(19) United States
(12) Patent Application Publication
(10) Pub. No.: US 2009/0139373 A1
(43) Pub. Date: Jun. 4, 2009

(54) Method for the production of a bimetallic saw blade, saw band or circular saw blade, and input stock for a saw blade or saw band

(76) Inventor: Karl Merz, Reinach (CH)

Correspondence Address: SUGHRUE MION, PLLC, 2100 PENNSYLVANIA AVENUE, N.W., SUITE 800, WASHINGTON, DC, 20037, US

(21) Appl. No.: 11/630,836

(22) PCT Filed: Jun. 21, 2005
(86) PCT No.: PCT/CH05/00342

§ 371 Date: Dec. 22, 2006

(30) Foreign Application Priority Data
Jun. 25, 2004 (CH) 1073/04

(51) Int. Cl. B23D 63/00; B32B 15/00

(52) U.S. Cl. 76/112; 428/615; 428/655

(57) ABSTRACT

Disclosed is a method for producing a bimetallic saw blade, saw band, or circular saw blade. According to said method, a support band (11) or a support disk made of a first metal is bonded to cutting material (16) made of a second metal in a first step, and said bond is machined in a material-removing manner so as to form a toothed profile (17a, b) in a second step, thus creating saw teeth that are at least partially made of the cutting material (16) by separating the teeth in a predetermined fashion. In order to simplify the production process and reduce the production effort in such a method, within the first step, holes (15) are first created in the support band (11) or the support disk according to the separation of the teeth, whereupon small insertion plates (16) which are made of the cutting material and entirely fill the holes (15) are inserted into said holes (15), and the edges of the small insertion plates (16) that are placed in the holes (15) are finally bonded to the support band (11) or the support disk.

### TECHNICAL FIELD

The present invention relates to the field of sawing technology. It relates to a method for the production of a bimetallic saw blade, saw band, or circular saw blade as claimed in the preamble of claim 1. It also relates to input stock for a saw blade or saw band.

### PRIOR ART

It has been known for a long time to produce saw blades or saw bands having teeth at the edge from two different metals, a steel adapted to the support function being used for the support band (in the case of elongated saw blades or saw bands) or the support disk (in the case of circular saw blades), and the teeth being made at least partly of a higher-grade alloy steel suitable for the cutting operations and long service life, e.g. high speed steel (HSS) (see, e.g., EP-A1-0 319 511 or EP-A2-0 566 560). In the past, different production methods, which have various disadvantages, have been proposed for such bimetallic saw blades or saw bands.

One method consists in welding a support band at a longitudinal edge to a strip of cutting material (HSS or the like) (see, e.g., U.S. Pat. No. 3,685,373 or U.S. Pat. No. 6,701,627) and, possibly after a few interposed rolling operations, in forming the desired tooth profile in the edge region of the welded-on strip by stock removal. In this case, the teeth may be made of the cutting material over the full circumference or may also be made partly of the cutting material (U.S. Pat. No. 5,091,264). The production and precise processing of the narrow strip of cutting material is comparatively complicated and leads to increased production costs. An additional factor in this respect is the fact that a considerable proportion of the cutting material is lost due to the stock removal when forming the tooth profile. Furthermore, the thermal loading on one side when welding on the strip leads to undesirable deformations of the bimetallic band, which have to be removed later in complicated rework steps.

In other methods, a block of support material having a central layer of cutting material is produced by powder-metallurgy or fusion processes and is then rolled down to a thin band and finally divided in half in order to obtain two subsequently workable support bands having a marginal region made of cutting material (U.S. Pat. No. 3,766,808 and U.S. Pat. No. 3,930,426). In these cases, the production of the band-shaped starting material involves comparatively high outlay, which results from both the production of the multi-layer block and the requisite rolling steps.

No less complicated are methods in which first of all strips of cutting material are welded in a planar manner onto both sides of a support band (U.S. Pat. No. 3,593,600).

Finally, for saw blades or saw bands, it is known from EP-A2-1 389 503 to produce input stock in which spaced-apart individual sections of a narrow band made of a cutting material are welded to the outer edge of a support band in order to form a respective base for a saw tooth to be prepared later. In this case, the sections may be welded directly onto the edge of the support band. However, it is also proposed to attach the sections in a sunk position in recesses in the support band. A disadvantage with this type of input stock is that, firstly, the support band having the welded-on sections of cutting material can only be manipulated with difficulty, because the welded-on sections result in an unevenly structured edge, and that, secondly, a comparatively high proportion of cutting material is lost when forming the teeth and has to be painstakingly removed. In addition, the positioning of the individual sections of cutting material at the edge of the support band for the joining process involves great difficulty.

### DESCRIPTION OF THE INVENTION

The object of the invention is therefore to specify a method for the production of a bimetallic saw blade, saw band, or circular saw blade which is distinguished by simplification of the method and by a marked reduction in the material and production outlay compared with the known methods and to provide corresponding input stock.

The object is achieved by the features of claim 1 and of claim 18 in their entirety. The essence of the invention consists in the fact that, to form the teeth, holes are first of all made in the support band or the support disk in accordance with the tooth spacing, that small insertion plates made of the cutting material are then inserted into the holes, which are filled by said small insertion plates, and that finally the small insertion plates sitting in the holes are bonded at the edges to the support band or the support disk. Since cutting material is used only at the locations at which the teeth are subsequently formed, a substantial saving of cutting material can be achieved. Since small flat plates are inserted into the holes of the support band or of the support disk, these, small plates can be punched out of a metal sheet in a simple manner, or can be cut out in another way, which metal sheet can be produced and processed in a substantially simpler and more cost-effective manner than a narrow strip of cutting material, as used in the prior art. Since the small insertion plates are completely surrounded at the edges by the support band or the support disk, the thermally induced deformation of the band during the bonding (brazing, welding) is considerably reduced or completely removed.

The holes and small insertion plates may in principle have the most varied shapes. In particular their edge contour may be designed in such a way that not much cutting material is lost with regard to the subsequent shape of the teeth. With regard to the processing and bonding, simple edge contours having higher symmetry are advantageous. The holes and small insertion plates therefore preferably have the edge contour of a polygon (triangle, square, pentagon, hexagon, octagon, etc.). However, especially simple conditions are obtained if the holes and small insertion plates have a round, in particular circular, edge contour.

Materials as are known from the publications mentioned at the beginning and as are familiar to the person skilled in the art may be used for the support band or the support disk and the small insertion plates. The small insertion plates are preferably made of a hardenable tool steel, in particular a high speed steel, and are hardened after being bonded to the support band or the support disk.

However, it is also conceivable for the small insertion plates to be made of a carbide. In this case, brazing in particular is suitable for the bonding between small insertion plates and support band or support disk.

If a support band is used, it is advantageous for the processing if the holes are made in the inner region of the support band, because the thermally induced deformation is then minimized. The conditions become especially simple if a support band is used having a width which is greater than or approximately equal to twice the width of the finished saw blade or saw band, if the holes are produced on a center line of the support band, if the support band, after being bonded to the small insertion plates, is divided into two sectional bands of preferably the same kind along a parting line extending in the longitudinal direction and running in each case through the small insertion plates, and if the two sectional bands are processed by stock removal, with a respective tooth profile being formed. In this case, the support band is preferably divided into two sectional bands by means of laser jet cutting.

The holes may be made in the support band or the support disk in different ways. A laser cutting method, for example, is conceivable. However, it is especially simple and cost-effective if the holes are made in the support band or the support disk by means of a punching operation.

Compared with the narrow band from the prior art, the small insertion plates have the advantage that they can be cut out, in particular punched out, of a larger metal sheet of cutting material in a simple and cost-effective manner.

A preferred configuration of the method according to the invention is distinguished by the fact that the small insertion plates sitting in the holes are bonded to the support band or the support disk by brazing, in particular inductive brazing, preferably with copper brazing metal. If small insertion plates made of a hardenable tool steel are used in this case, it is especially advantageous and especially time-saving and energy-saving if the small insertion plates, after being brazed in place, are hardened using the heat resulting therefrom.

However, it is also readily possible for the small insertion plates sitting in the holes to be bonded to the support band or the support disk by welding, in particular by means of laser beam or electron beam.

So that the inserted small insertion plates are correctly positioned for further processing, it is advantageous if the small insertion plates, after being inserted into the holes and before being bonded to the support band or the support disk, are fixed in the holes. In particular, it has proved successful for the small insertion plates to be fixed in the holes by embossing.

The method becomes especially simple if, according to another configuration, in a single process step, the small insertion plates are punched out of a larger metal sheet made of cutting material and are inserted into the holes in the support band or in the support disk, or if, in a single process step, the small insertion plates are punched out of a larger metal sheet (30) made of cutting material, the holes are punched in the support band or in the support disk, and the punched-out small insertion plates are inserted into the holes in the support band or in the support disk.

The input stock according to the invention is based on a support band or a support disk made of a first metal and is characterized in that there are holes in the support band or the support disk, in that small insertion plates made of a cutting material are inserted into the holes, the holes being filled by said small insertion plates, and in that the small insertion plates sitting in the holes are bonded at the edges to the support band or the support disk.

Further configurations follow from the dependent claims.

### BRIEF EXPLANATION OF THE FIGURES

The invention is to be explained in more detail below with reference to exemplary embodiments in connection with the drawing, in which:

FIG. 1 shows two finished saw blades or saw bands in a plan view, as are produced in a preferred exemplary embodiment of the method according to the invention;

FIG. 2 shows, in several figure parts (FIGS. 2a-e), various steps for producing the saw blades or saw bands shown in FIG. 1;

FIG. 3 shows the punching-out of the (round) small insertion plates of cutting material from a larger metal sheet;

FIG. 4 shows the fixing of the small insertion plates in the holes of the support band by means of an embossing operation according to a preferred configuration of the method according to the invention;

FIG. 5 shows the sequence in principle of the brazing and subsequent hardening of the small insertion plates according to a preferred configuration of the method according to the invention;

FIG. 6 shows, in plan view, a support disk provided with holes for producing a circular saw blade according to the method according to the invention;

FIG. 7 shows the sequence in principle during beam welding of the small insertion plates to the support band according to a preferred configuration of the method according to the invention;

FIG. 8 shows, in two figure parts (FIGS. 8a and 8b), alternative division of the support band compared with FIGS. 2d and 2e along another parting line, at which the subsequent saw teeth adjoin one another with their cutting edges;

FIG. 9 shows, in a schematic illustration, a configuration of the method according to the invention, in which the punched-out small insertion plates are pressed directly into the underlying holes of the support band or of the support disk; and

FIG. 10 shows, in an illustration comparable with FIG. 9, a further configuration of the method according to the invention, in which, with the punching-out of the small insertion plates, the holes in the underlying support band or support disk are punched out at the same time, and the punched-out small insertion plates are pressed into the resulting holes in the support band or in the support disk.

### WAYS OF IMPLEMENTING THE INVENTION

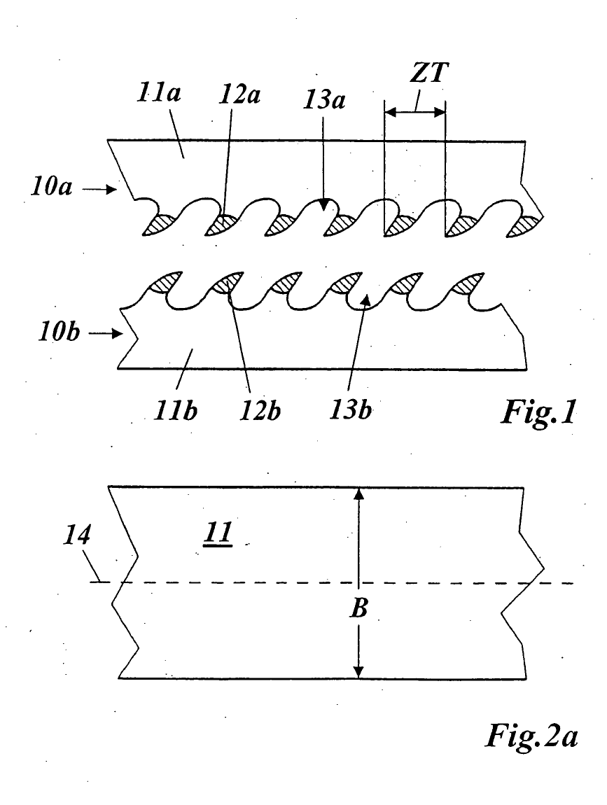

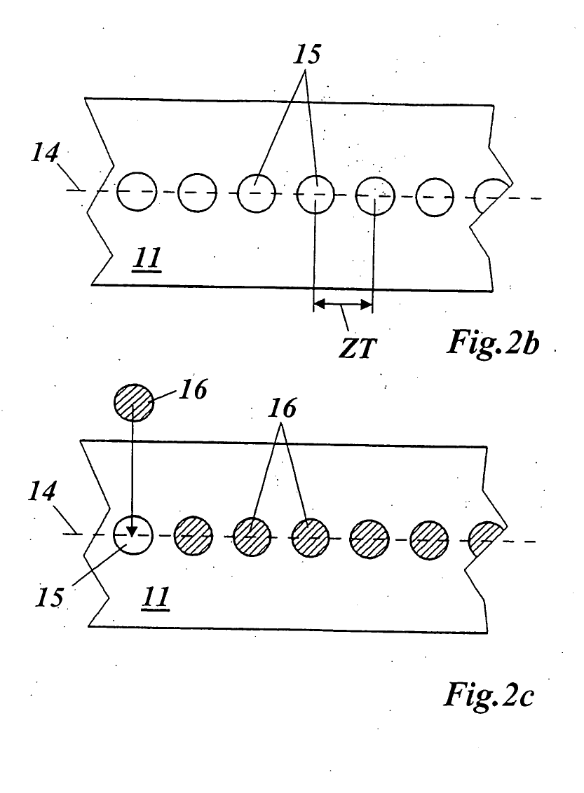

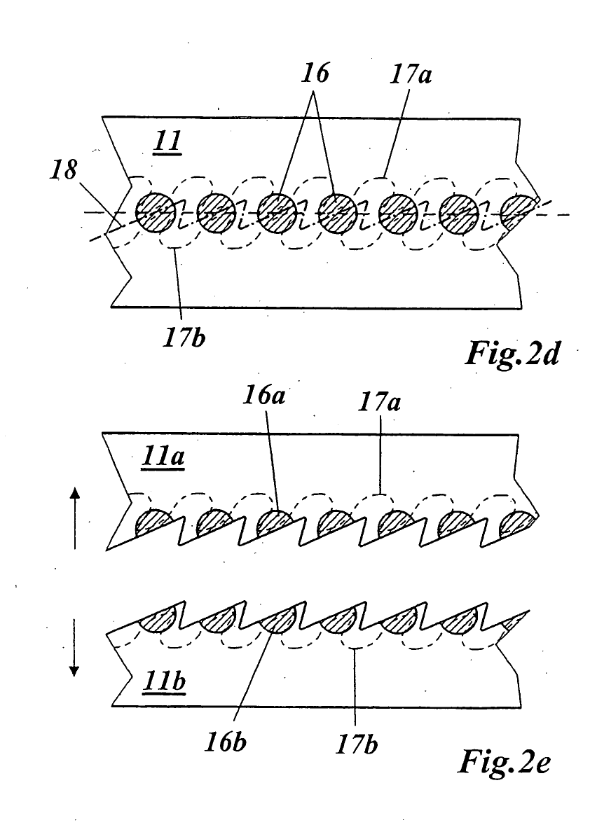

Reproduced in FIG. 2 in several figure parts 2a to 2e are various steps for the production of a pair of saw blades or saw bands 10a, b according to the invention, as are shown in FIG. 1. According to FIG. 2a, the starting point is a support band 11 made of a suitable support band material (a steel or the like), as is well known from the prior art mentioned at the beginning. The thickness D of the support band 11 (FIG. 4) (preferably produced by rolling) is within the range of about 0.5 to 3 mm. The width B of the support band is selected in such a way that it is greater than or approximately equal to the width of the subsequent saw blades or saw bands 10a, b.

According to FIG. 2b, in the support band 11, holes are made continuously along or on the center line 14 of the support band 11 in a first step by punching, laser cutting or another suitable method, the spacing of which holes 15 (hole center to hole center) corresponds to the tooth spacing ZT of the subsequent saw blade or saw band 10a, b. In the example shown, the holes 15 have a circular edge contour. However, they may also be edged in another way and may have, for example, the shape of a polygon, an ellipse or the like. In this case, the circular edge contour has the advantage of high symmetry and ease of production and processing.

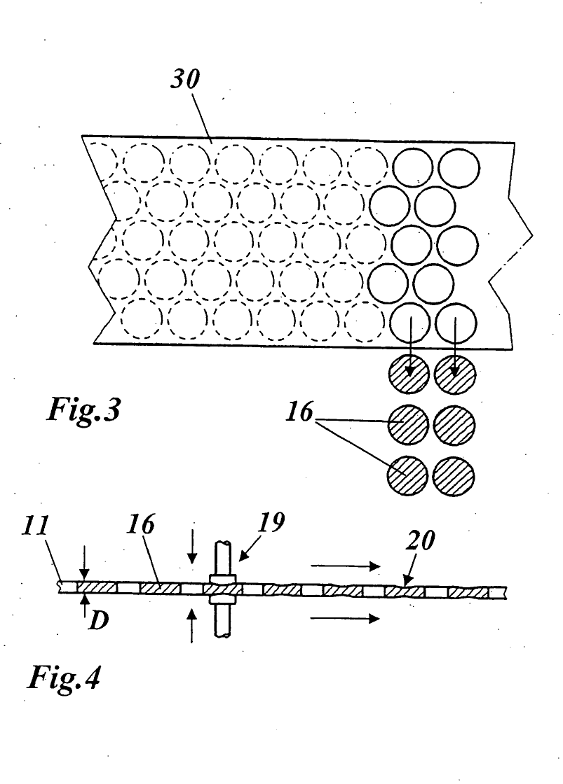

According to FIG. 2c, matching small insertion plates 16, the thickness of which preferably corresponds to the thickness D of the support band 11, are then inserted into the holes 15 in the support band 11. The small insertion plates 16 are made of a material which is especially suitable for the saw teeth and is different from the support band 11. A hardenable tool steel, in particular a high speed steel (HSS), as is known in a variety of forms from tool engineering, has proved successful for this purpose. The small insertion plates 16 are preferably punched out or cut out of a larger metal sheet 30 according to FIG. 3, a considerable cost advantage over the prior art being obtained on account of the simplified processing in the case of a metal sheet. High material utilization is achieved by an arrangement of the punched holes with the densest packing.

However, it is also conceivable to use small insertion plates 16 made of carbide, as used for cutting tips for example. The small insertion plates 16 preferably have the same shape and edge contour as the holes 15, so that they completely fill the holes 15 and bear closely with their outer edge against the inner edge of the holes 15. During the subsequent bonding, the small insertion plates 16 are then connected to the support band 11 over the entire length of their edge. In particular with regard to the subsequent tooth shape, however, the small insertion plates 16 may also be shaped in such a way that they bear against the support band 11 and are connected to it only via certain sections of their edge.

When the small insertion plates 16 are inserted into the holes 15 of the support band 11, the further processing steps are facilitated by the small insertion plates 16 being fixed in their position in the holes 15 until they are finally bonded to the support band. Fixing can be achieved in an especially simple manner according to FIG. 4 by an embossing operation in an embossing device 19. During this embossing operation, a respective impression 20 is produced in the center of the small insertion plates 16 by means of a suitable embossing punch. The material displaced with the impression 20 flows outward and increases the diameter of the insertion plate 16, so that the edge of the small plate 16 is pressed against the inner wall of the hole 15 and fixes the position. However, it is also conceivable to fix the small insertion plates 16 by placing weld spots at the edges.

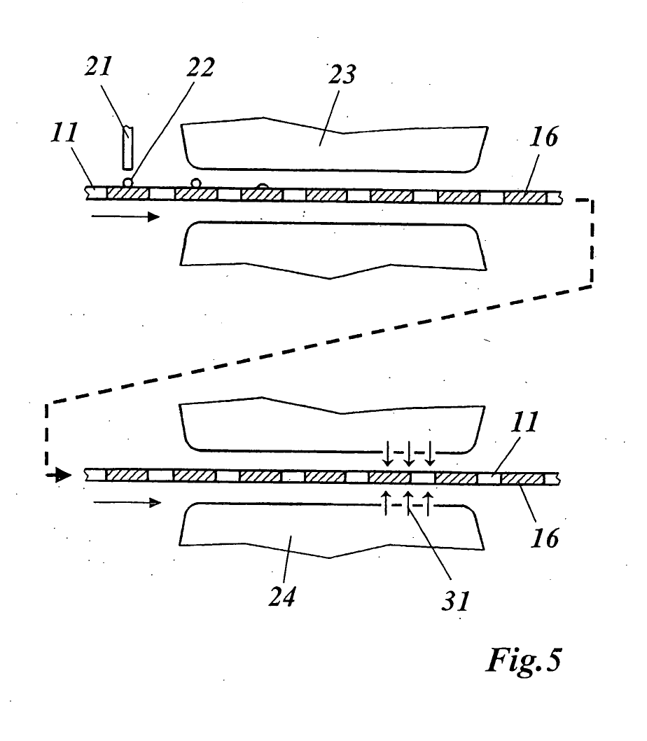

After the small insertion plates 16 have been fixed in the holes 15 of the support band 11, the small insertion plates 16 and the support band 11 are bonded to one another at the edge of the small plates. In the case of small insertion plates 16 made of hardenable tool steel, a brazing method with following hardening process is preferred for this purpose according to FIG. 5. To this end, the support band 11 with the inserted and fixed small insertion plates 16 is directed through a brazing device 23, in which it is preferably heated inductively. Before the respective section of the support band 11 enters the brazing device 23, a suitable brazing metal, e.g. a copper brazing metal, is applied to the respective small insertion plates by means of a brazing-metal-application device 21. When the support band 11 with the brazing metal 22 enters the brazing device 23, the brazing metal 22 and the support band 11 are heated to the requisite temperature (e.g. ≧1150° C.), and the brazing metal 22 melts and is drawn into the annular gap between small insertion plates 16 and support band 11. The heat introduced into the support band during the brazing can be advantageously used in order to carry out a following hardening operation. To this end, according to FIG. 5, the support band 11 is fed directly after the brazing to a hardening device 24, where the small insertion plates 16 are hardened in accordance with the hardening specifications valid for their material, in particular by quenching by means of a sprayed-in liquid or gaseous cooling medium 31.

Instead of brazing, if the small insertion plates 16 are made of a weldable material, a welding method, in particular by means of laser beam or electron beam, may also be used as a bonding method (FIG. 7). A corresponding beam 28 and/or 29 from a beam source 26 or 27, respectively, is then directed on one side or both sides along the edge contour of the small insertion plates 16.

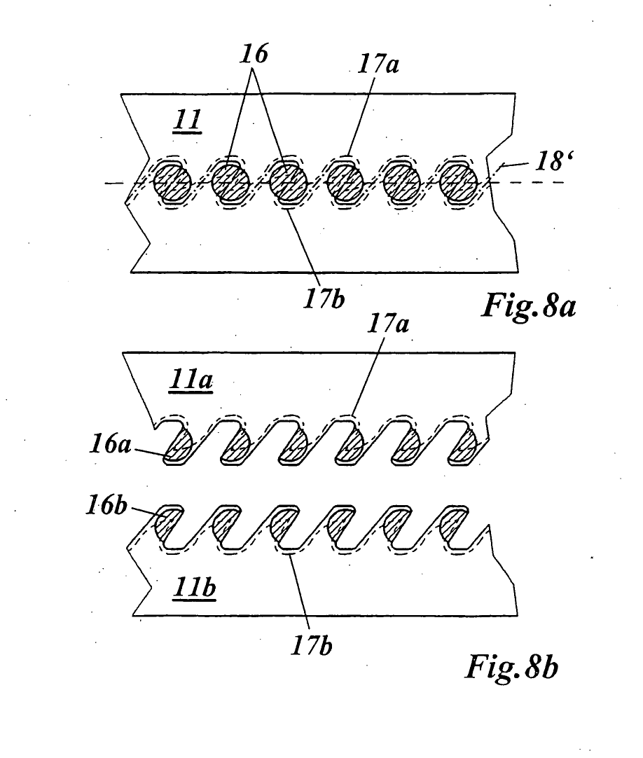

Once the support band 11 and the small insertion plates 16 have been bonded to one another in this way, the support band 11 is separated according to FIGS. 2d and 2e (or according to FIGS. 8a and 8b) into two sectional bands of the same kind (support bands 11a, b in FIG. 1) along a predetermined parting line 18 or 18′. The zigzag parting line 18 or 18′ is selected with regard to the two subsequent tooth profiles 17a and 17b of the two separate saw blades or saw bands 10a, b in such a way that the small insertion plates 16 are each divided in half into two small insertion plate sections 16a, b, each small plate half or each small insertion plate section 16a, b being sufficient for forming a saw tooth. The two separated sectional bands 11a, b merge into one another by rotation through 180°. This ensures that two saw blades 10a, b of the same kind are produced by the same processing steps. From the two sectional bands 11a, b present according to FIG. 2e and having the small plate halves brazed in place, the tooth profiles 17a, b with their saw teeth 12a, b and the tooth gaps 13a, b in between can then be formed by stock removal until the saw blades or saw bands 10a, b are present in the final form shown in FIG. 1. Whereas in the case of the parting line 18 from FIG. 2d the subsequent saw teeth 12a, b adjoin one another with their backs within the small insertion plates 16, the parting line 18′ from FIG. 8a predetermines a separation during which the subsequent saw teeth 12a, b adjoin one another with their cutting edges. However, in connection with other shapes of small insertion plates 16 and tooth profiles 17a, b, other parting lines are also conceivable.

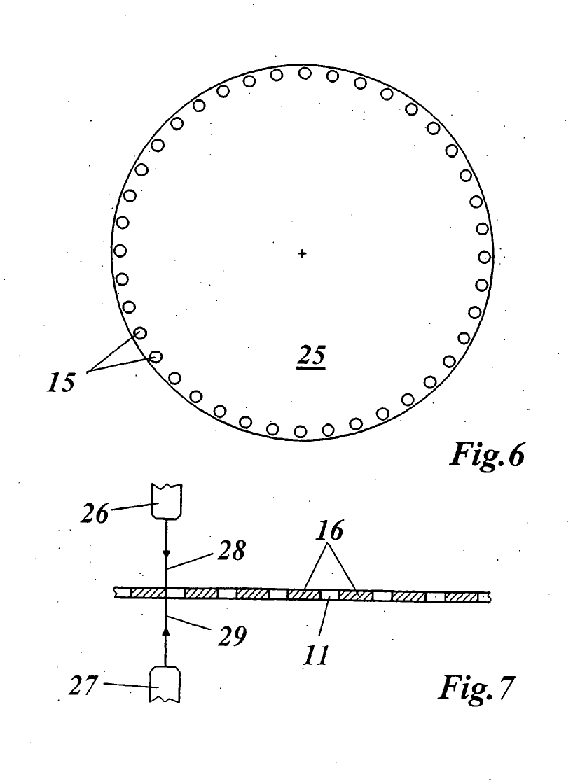

According to FIG. 6, a circular support disk 25 in which the holes 15 are made around the circumferential edge region is taken as a basis if a circular saw blade is to be produced with the method according to the invention. The small insertion plates 16 are then correspondingly inserted into the holes 15, are fixed and are bonded to the support disk 25 (by brazing or the like) and are hardened if need be. The desired tooth profile is then produced by stock removal.

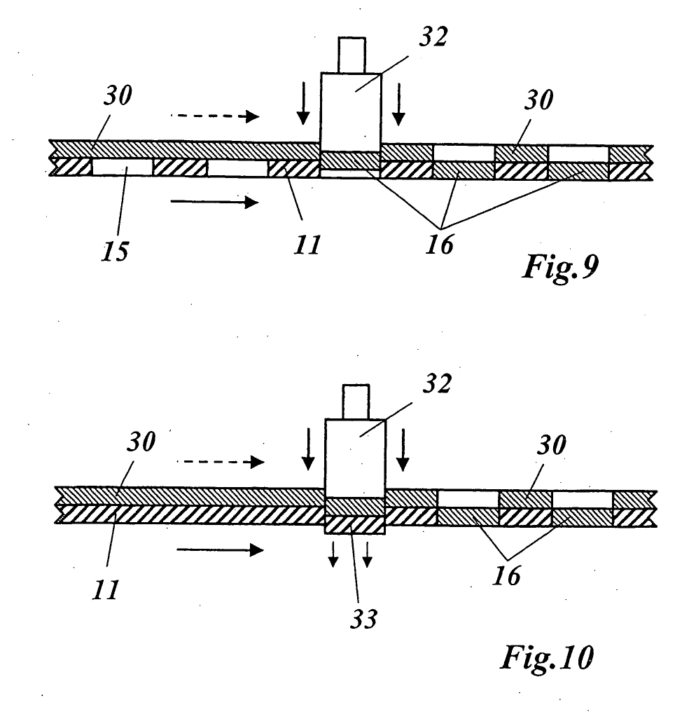

Especially simple and elegant configurations of the method according to the invention are reproduced schematically in FIGS. 9 and 10. In the configuration in FIG. 9, a support band 11 or a support disk in which the holes 15 necessary for the small insertion plates 16 are already made is taken as a basis. The metal sheet 30 made of the cutting material from which the small insertion plates 16 are to be punched out is then placed over the support band 11 or the support disk. A punching device having a suitable punching tool 32 is used for punching out the small insertion plates 16. The perforated support band 11 is now guided and adjusted relative to the punching tool 32 of the punching device in such a way that the holes 15 punched out therein are in alignment with the punching tool 32. A small insertion plate 16 is then punched out of the metal sheet 30 by the punching tool 32 and is pressed in the course of the punching movement into the hole 15, lying exactly underneath, in the support band 11. At the same time, the small insertion plate 16 can be fixed in the hole 15 by an embossing operation. Indicated in FIG. 9 by arrows is the fact that the support band 11 and metal sheet 30 are moved in the same direction relative to the punching tool between the punching operations. However, the metal sheet 30 can of course also be moved in a different direction, e.g. transversely to or at angle to the support band, in order to use the width of the metal sheet 30 for punching out the small insertion plates 16. This consideration also applies to the configuration according to FIG. 10.

In the configuration shown in FIG. 10, an unperforated support band is used instead of the preperforated support band. Here, with the punching-out of the small insertion plate 16, the requisite hole 15 is punched out of the underlying support band 11 at the same time, a small punched-out plate 33 being produced and falling downward. During the same operation, the small punched-out small insertion plates 16 are pressed into the hole produced and are fixed if need be. In this case, the small insertion plate 16 made of cutting material acts as part of the punching tool 32.

On the whole, the invention results in a method for the production of a bimetallic saw blade or saw band or circular saw blade which is distinguished by the following characteristic features and advantages:
Through the use of small flat small insertion plates, the starting material used for the teeth may be a metal sheet, which is simple and inexpensive to produce and from which the individual small insertion plates are punched out or cut out.
Since the cutting material is introduced into the support material only in the region of the subsequent teeth, the material consumption is reduced; this applies in particular to the production of saw blades or saw bands in pairs by dividing a wider support band having small insertion plates inserted centrally.
Since the small insertion plates lie more in the interior of the support band or the support disk and are entirely surrounded by the support material, the thermally induced deformation when the small plates are being brazed or welded in place is slight; this applies in particular if the small insertion plates are arranged symmetrically in the center line of the support band.
The production can be effected with a support band and small insertion plates whose thickness is approximately equal to the thickness of the subsequent saw blade; complicated rolling cuts can thus be avoided.
In FIG. 2e and FIG. 8b, the teeth can be ground in such a way that they are supported against cutting forces on the opposite side of the cutting edge by the support band (connecting line of support band/small insertion plates runs perpendicular to the band direction); this is an important advantage over a weld in the sawing direction, as is the case in EP-A2-1 389 503.
During the production of double saw blades, the outer edges are freely accessible for simultaneous processing and can be processed simultaneously before the separation of the bands (in order to be suitable later for roller guides); the processing is simplified as a result.

### LIST OF DESIGNATIONS

10a, b Saw blade, saw band
11, 11a, b Support band
12a, b Saw tooth
13a, b Tooth gap
14 Center line (support band)
15 Hole
16 Small insertion plate
16a, b Small insertion plate section
17a, b Tooth profile
18, 18′ Parting line
19 Embossing device
20 Impression
21 Brazing-metal-application device
22 Brazing metal
23 Brazing device
24 Hardening device
25 Support disk
26, 27 Beam source (laser, electron beam)
28, 29 Beam (laser beam, electron beam)
30 Metal sheet
31 Cooling medium
32 Punching tool
33 Punched-out plate
B Width (support band)
D Thickness (support band, small insertion plate)
ZT Tooth spacing

1. A method for the production of a bimetallic saw blade, saw band (10a, b), or circular saw blade, in which method a support band (11; 11a, b) or a support disk (25) made of a first metal is bonded to cutting material (16) made of a second metal in a first step and the composite is processed by stock removal in a second step, with a tooth profile (17a, b) being formed, saw teeth (12a, b) being produced which have a predetermined tooth spacing (ZT) and are made at least partly of the cutting material (16), characterized in that, during the first step, holes (15) are first of all made in the support band (11; 11a, b) or the support disk (25) in accordance with the tooth spacing (ZT), small insertion plates (16) made of the cutting material are then inserted into the holes (15), the holes (15) being filled by said small insertion plates (16), and finally the small insertion plates (16) sitting in the holes (15) are bonded at the edges to the support band (11; 11a, b) or the support disk (25).

2. The method as claimed in claim 1, characterized in that the holes (15) and small insertion plates (16) have the edge contour of a polygon.

3. The method as claimed in claim 1, characterized in that the holes (15) and small insertion plates (16) have a round, in particular circular, edge contour.

4. The method as claimed in one of claims 1 to 3, characterized in that the small insertion plates (16) are made of a hardenable tool steel, in particular a high speed steel, and are hardened after being bonded to the support band (11; 11a, b) or the support disk (25).

5. The method as claimed in one of claims 1 to 3, characterized in that the small insertion plates (16) are made of a carbide.

6. The method as claimed in one of claims 1 to 5, characterized in that a support band (11) is used, and in that the holes (15) are made in the inner region of the support band (11).

7. The method as claimed in claim 6, characterized in that a support band (11) is used having a width (B) which is greater than or approximately equal to twice the width of the finished saw blade or saw band (10a, b), in that the holes (15) are produced on a center line (14) of the support band (11), in that the support band (11), after being bonded to the small insertion plates (16), is divided into two sectional bands (11a, b) of preferably the same kind along a parting line (18, 18′) extending in the longitudinal direction and running in each case through the small insertion plates (16), and in that the two sectional bands (11a, b) are processed by stock removal, with a respective tooth profile (17a, b) being formed.

8. The method as claimed in claim 7, characterized in that the support band (11) is divided into two sectional bands (11a, b) by means of laser jet cutting.

9. The method as claimed in one of claims 1 to 8, characterized in that the holes (15) are made in the support band (11; 11a, b) or the support disk (25) by means of a punching operation.

10. The method as claimed in claim 4, characterized in that the small insertion plates (16) are cut out, in particular punched out, of a larger metal sheet (30) of cutting material.

11. The method as claimed in one of claims 1 to 10, characterized in that the small insertion plates (16) sitting in the holes (15) are bonded to the support band (11; 11a, b) or the support disk (25) by brazing, in particular inductive brazing, preferably with copper brazing metal.

12. The method as claimed in claim 11, characterized in that small insertion plates (16) made of a hardenable tool steel are used, and in that the small insertion plates (16), after being brazed in place, are hardened using the heat resulting therefrom.

13. The method as claimed in claim 4, characterized in that the small insertion plates (16) sitting in the holes (15) are bonded to the support band (11; 11a, b) or the support disk (25) by welding, in particular by means of laser beam or electron beam (28, 29).

14. The method as claimed in one of claims 1 to 13, characterized in that the small insertion plates (16), after being inserted into the holes (15) and before being bonded to the support band (11; 11a, b) or the support disk (25), are fixed in the holes (15).

15. The method as claimed in claim 14, characterized in that the small insertion plates (16) are fixed in the holes (15) by embossing.

16. The method as claimed in one of claims 1 to 15, characterized in that, in a single process step, the small insertion plates (16) are punched out of a larger metal sheet (30) made of cutting material and are inserted into the holes (15) in the support band (11; 11a, b) or in the support disk (25).

17. The method as claimed in one of claims 1 to 15, characterized in that, in a single process step, the small insertion plates (16) are punched out of a larger metal sheet (30) made of cutting material, the holes (15) are punched in the support band (11; 11a, b) or in the support disk (25), and the punched-out small insertion plates (16) are inserted into the holes (15) in the support band (11; 11a, b) or in the support disk (25).

18. Input stock for a saw blade or saw band, comprising a support band (11; 11a, b) or a support disk (25) made of a first metal, characterized in that there are holes (15) in the support band (11; 11a, b) or the support disk (25), in that small insertion plates (16) made of a cutting material are inserted into the holes (15), the holes (15) being filled by said small insertion plates (16), and in that the small insertion plates (16) sitting in the holes (15) are bonded at the edges to the support band (11; 11a, b) or the support disk (25).

19. The input stock as claimed in claim 18, characterized in that the holes (15) and small insertion plates (16) have the have the edge contour of a polygon.

20. The input stock as claimed in claim 18, characterized in that the holes (15) and small insertion plates (16) have a round, in particular circular, edge contour.

21. The input stock as claimed in one of claims 18 to 20, characterized in that the small insertion plates (16) are made of a hardenable tool steel, in particular a high speed steel.

22. The input stock as claimed in one of claims 18 to 20, characterized in that the small insertion plates (16) are made of carbide.

23. The input stock as claimed in one of claims 18 to 22, characterized in that a support band (11) is present having a width (B) which is greater than or approximately equal to twice the width of the finished saw blade or saw band (10a, b), and in that the holes (15) are arranged on a center line (14) of the support band (11).

24. The input stock as claimed in one of claims 18 to 23, characterized in that the small insertion plates (16) sitting in the holes (15) are bonded to the support band (11; 11a, b) or the support disk (25) by brazing, in particular inductive brazing, preferably with copper brazing metal.

25. The input stock as claimed in claim 21, characterized in that the small insertion plates (16) sitting in the holes (15) are bonded to the support band (11; 11a, b) or the support disk (25) by welding, in particular by means of laser beam or electron beam (28, 29).
